(19) United States
(12) Patent Application Publication
(10) Pub. No.: US 2013/0181965 A1
(43) Pub. Date: Jul. 18, 2013

(54) DRIVING CIRCUIT FOR PANEL

(71) Applicant: SITRONIX TECHNOLOGY CORP., Hsinchu County (TW)

(72) Inventor: CHUNG-HSIN SU, HSINCHU COUNTY (TW)

(73) Assignee: SITRONIX TECHNOLOGY CORP., HSINCHU COUNTY (TW)

(21) Appl. No.: 13/739,346

(22) Filed: Jan. 11, 2013

Related U.S. Application Data
(60) Provisional application No. 61/587,685, filed on Jan. 18, 2012.

(51) Int. Cl. G09G 3/36

(52) U.S. Cl. CPC G09G 3/3696
USPC 345/211; 345/87

(57) ABSTRACT

The present invention provides a driving circuit for panel, which comprises a gamma voltage generating circuit, a plurality of selecting units, and at least a source driving circuit. The gamma voltage generating circuit generates a plurality of gamma voltages for the plurality of selecting units. The plurality of selecting units outputs the plurality of gamma voltages generated by the gamma voltage generating circuit using the time-division method according to selection data to the source driving circuit. According to display data, the source driving circuit selects to receive the gamma voltage of an output of the plurality of selecting units as a target voltage. In addition, the source driving circuit produces a driving signal according to the target voltage for driving a panel.

This Application is based on Provisional Patent Application Ser. No. 61/587,685, filed 18 Jan. 2012, currently pending.

### FIELD OF THE INVENTION

The present invention relates generally to a driving circuit for panel, and particularly to a driving circuit for panel that reduces the interconnection substantially inside the chip and thus reducing the chip size, power consumption, and manufacturing cost drastically.

### BACKGROUND OF THE INVENTION

Currently, the panel of thin-film transistor liquid crystal display (TFTLCD) has been applied extensively to various kinds of equipment, such as televisions, computer displays, mobile phone displays, or billboards. The driving method of TFTLCD is to control on/off of the gate in a pixel by using a gate driving circuit, and output the accurate voltage into the pixel using a source driving circuit. In addition, the voltage output by the source driving circuit is generated by a gamma voltage generating circuit. Thereby, the driving circuit of LCD controls the orientations of the liquid crystals in the display for producing the correct colors on LCD.

Each of the source driving circuit in an LCD according to the prior art comprises devices such as a digital-to-analog converter (DAC) and a buffer. Nonetheless, an LCD according to the prior art contains hundreds of source driving circuits. The circuit for interconnecting DACs and gamma voltage generating circuits will occupy the largest area. This situation is especially more serious in the display technologies requiring high pixels. Consequently, the technology of reducing the chip area without increasing substantial power consumption has become very important. Based on the above description, when the color data of a LCD is 6 bits, the DAC will need 2⁶ pins. Likewise, the gamma voltage generating circuit will need 64 pins as well for leading 64 connecting wires to the DAC and providing gamma voltages with 6-bit resolution, namely, 64 gamma voltages. If the gamma voltage generating circuits for red R, green G, and blue B are independent, then the gamma voltages for R, G, and B will be generated by three gamma generating circuits, which require 192 connecting wires to the DAC. For an 8-bit high-resolution LCD with independent gamma voltage generating circuits for R, G, and B, the pin count for the gamma voltage generating circuit will be 768; there will be 768 connecting wires for interconnecting the DAC and the gamma voltage generating circuits.

Accordingly, the required pin count for the driving circuit in the LCD according to the prior art and the circuit area for interconnecting various devices are extremely huge. For solving the drawbacks, the present invention adopts a time-division method for reducing the pin count for the driving circuit and the circuit area for interconnecting various devices. Thereby, the manufacturing cost for the driving circuit of LCD and unnecessary power consumption can be reduced.

### SUMMARY

An objective of the present invention is to provide a driving circuit for panel, which reduces substantially the interconnection between the DAC of each source driving circuit and the inside of the chip for reducing the circuit area as well as the manufacturing cost.

The present invention provides a driving circuit for panel, which comprises a gamma voltage generating circuit, a plurality of selecting units, and at least a source driving circuit. The gamma voltage generating circuit generates a plurality of gamma voltages for the plurality of selecting units. The plurality of selecting units outputs the plurality of gamma voltages generated by the gamma voltage generating circuit using the time-division method according to selection data to the source driving circuit. According to display data, the source driving circuit selects to receive the gamma voltage of an output of the plurality of selecting units as a target voltage. In addition, the source driving circuit produces a driving signal according to the target voltage for driving a panel.

### BRIEF DESCRIPTION OF THE DRAWINGS

FIG. 1 shows a block diagram of the gate driving circuit according to the present invention;

FIG. 2 shows a block diagram of the source driving circuit according to the present invention;

FIG. 3 shows a timing diagram of the selection data according to the present invention;

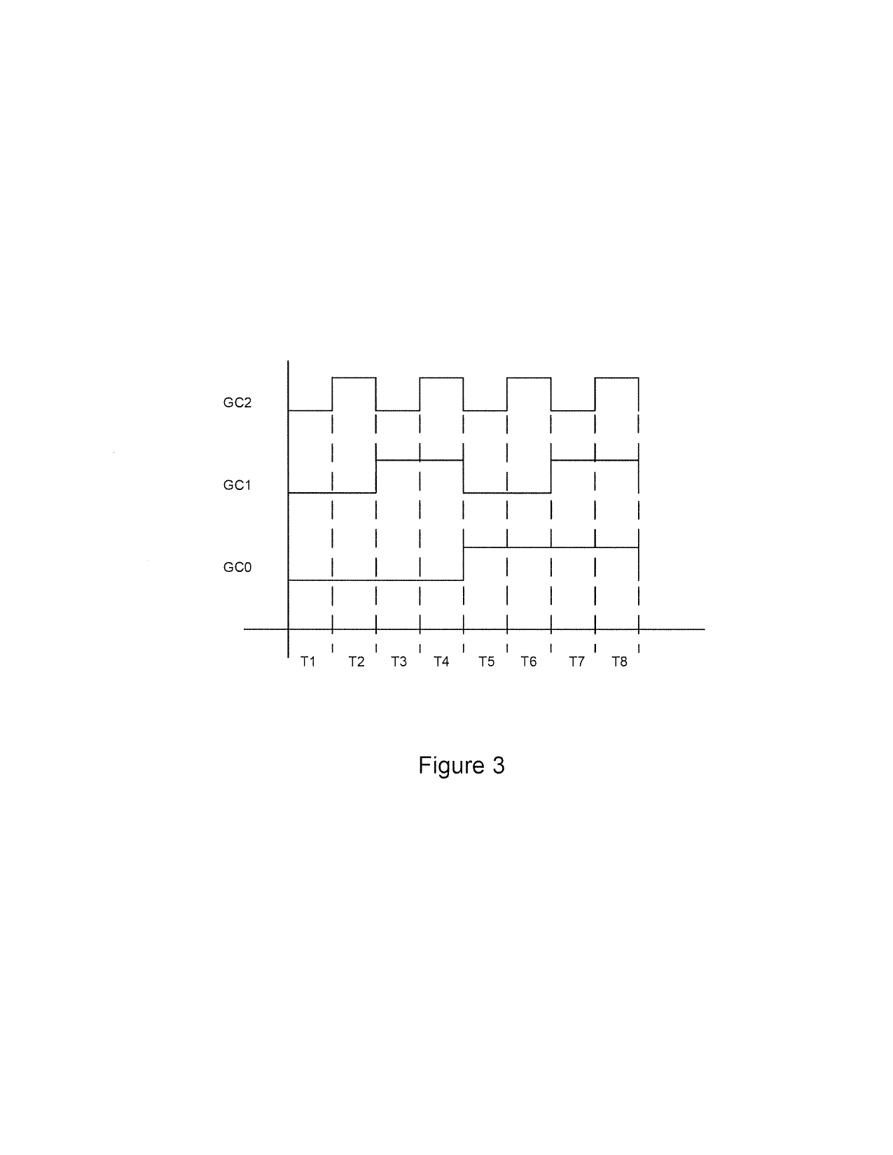

FIG. 4 shows a gamma voltage table of the gamma voltage generating circuit according to the present invention;

FIG. 5 shows a selection table of the output voltage according to the present invention;

FIG. 6 shows a DAC circuit according to an embodiment of the present invention; and

FIG. 7 shows another block diagram of the source driving circuit according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention is devoted to reducing the areas of interconnection between the DAC of each source driving circuit and the inside of the chip for increasing the usable area in circuits or reducing the size of the circuit board. Thereby, the manufacturing costs for various electronic devices can be reduced or the sizes of electronic devices can be shrunk. The present invention can be applied to the electronic products that transmit a large number of series of relevant logic data or electrical signals and reduce the interconnection in the chip therein. The driving circuit for panel will used as an example for describing the technical details of the present invention.

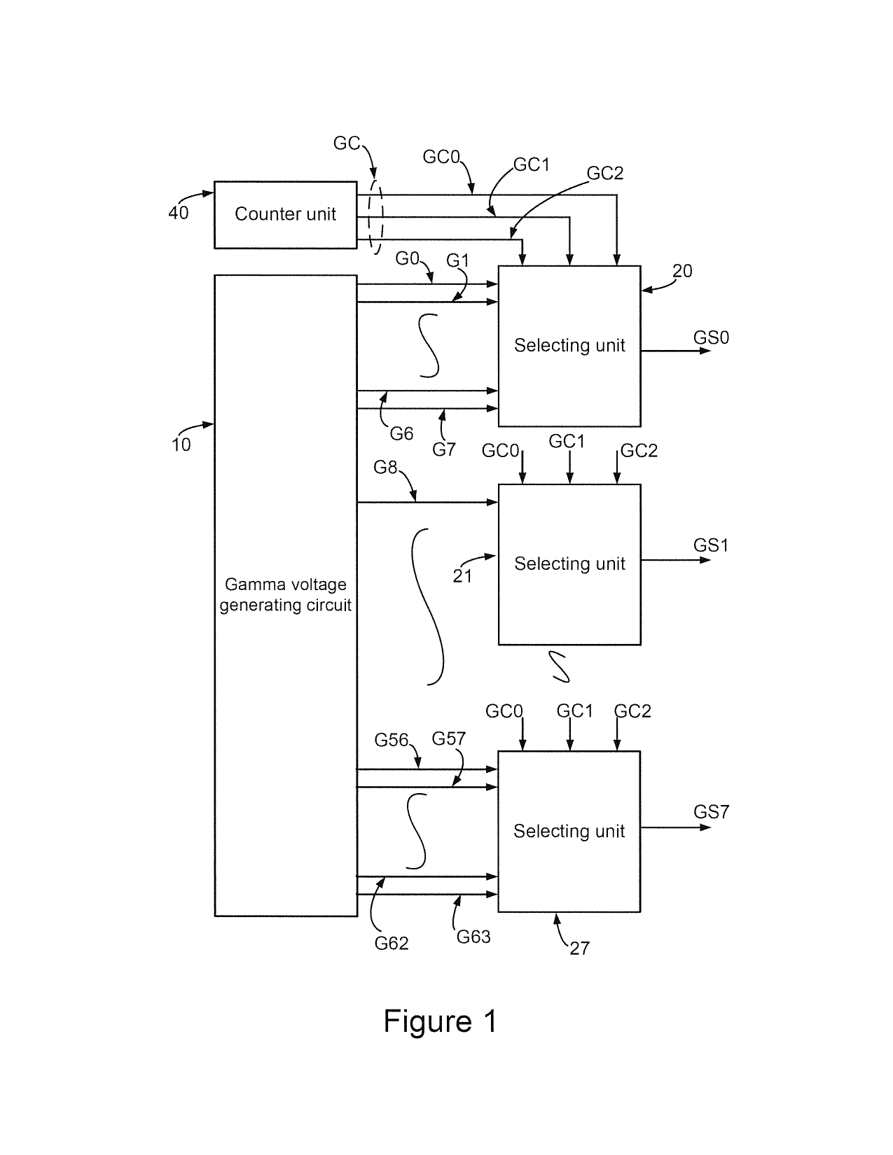

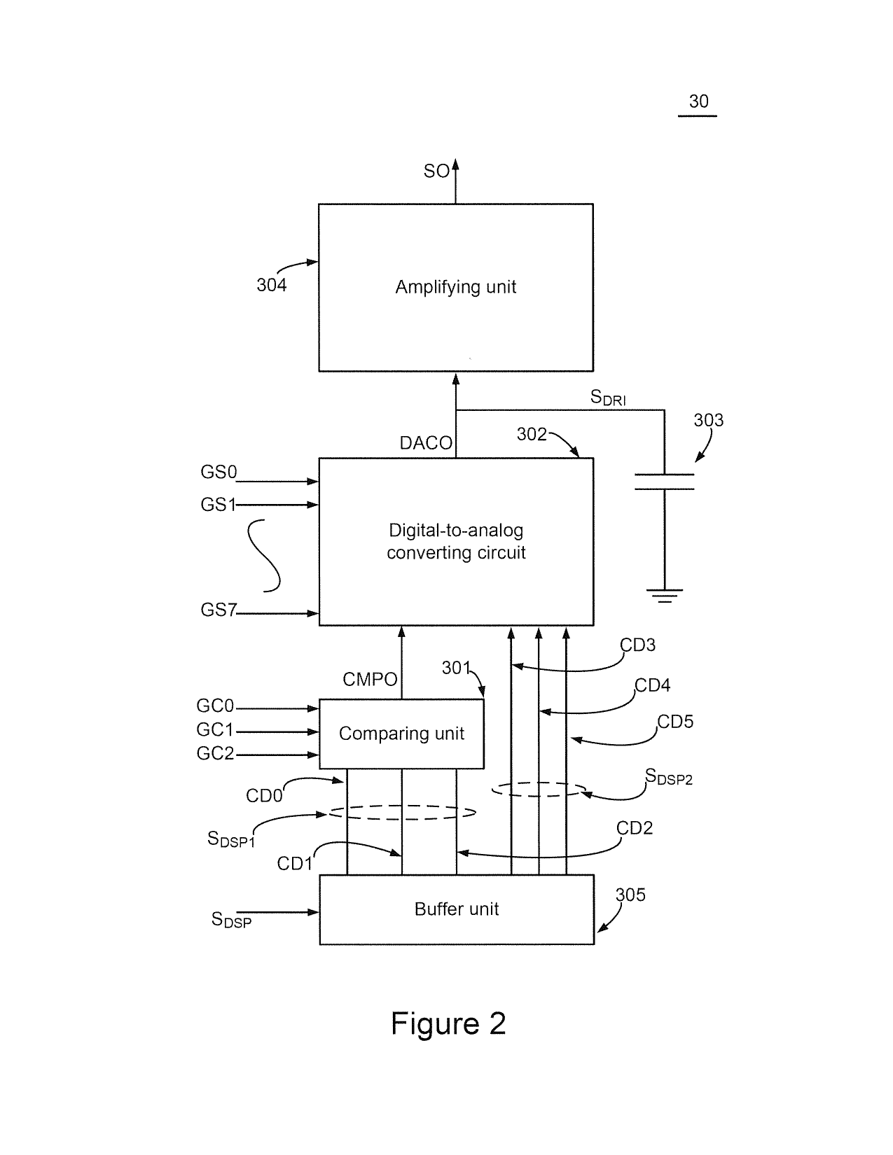

First, FIG. 1 and FIG. 2 show block diagram of the driving circuit for panel according to the present invention. As shown in the figure, the present invention comprises a gamma voltage generating circuit 10, a plurality of selecting units 20˜27, and at least a source driving circuit 30 for reducing substantially the interconnection in the chip. The gamma voltage generating circuit 10 generates a plurality of gamma voltages G0˜G63. The plurality of selecting units 20˜27 are coupled to the gamma voltage generating circuit 10, and output the plurality of gamma voltages G0˜G64 in the time-division method according to selection data GC. The source driving circuit 30 is coupled to the plurality of selecting units 20˜27, and selects to receive the gamma voltage GS0 . . . GS6, or GS7 output by one of the plurality of selecting units 20˜27 as a target voltage V_{TAR} according to display data S_{DSP}. Besides, the source driving circuit 30 produces a driving signal SO according to the target voltage V_{TAR} for driving a panel.

The plurality of gamma voltages G0˜G63 are generated by the gamma voltage generating circuit 10 according to a gamma curve. According to the present embodiment, the gamma curve is divided into 64 segments of voltages for generating the plurality of gamma voltages G0˜G63. The technology that the gamma voltage generating circuit 10 generates the plurality of gamma voltages G0˜G63 according to the gamma curve is well known to a person having ordinary skill in the art, and hence will not be described in details.

The plurality of selecting units 20˜27 according to the present invention are multiplexers, which can be composed by decoders and a plurality of logic gates or by a plurality of switches and switch control circuits. The circuit architecture of the plurality of selecting units 20˜27 will not be described in details here. The plurality of selecting units 20˜27 are coupled to the gamma voltage generating circuit 10, and output the plurality of gamma voltages G0˜G63 generated by the gamma voltage generating circuit 10 in the time-division method according to the selection data GC. The selection data GC according to the present embodiment include 3-bit binary logic data GC0, GC1, GC2. Namely, the logic data GC0, GC1, GC2 are 0 (low level) or 1 (high level), respectively. When the selection data GC are 0, it means that the logic data GC0, GC1, GC2 are 0, 0, and 0, respectively. If the selection data GC are 1, it means that the logic data GC0, GC1, GC2 are 1, 0, and 0, respectively. If the selection data GC are 7, it means that the logic data GC0, GC1, GC2 are 1, 1, and 1, respectively. The rest may be deduced by analogy.

The selection data GC described above can be generated by a counter unit 40, a clock generating unit, or a level generating unit. According to the embodiment of the present invention, the counter unit 40 is used for describing how the selection data GC are generated. The counter unit 40 is coupled to the plurality of selecting unit 20˜27 and produces sequentially the section data GC according a time sequence T1 . . . T7, or T8. Here the time sequence T1 . . . T7, or T8 are the corresponding time sequences when the counter unit 40 generates the logic data GC0, GC1, GC2 sequentially. For example, as shown in Figure, at the first time sequence T1 the first selection data GC are 000; at the second time sequence T2, the second selection data GC are 100; at the third time sequence T3, the third selection data GC are 010, and so on. Thereby, at each time sequence T1˜T8, an individual set of selection data GC will be generated. At each time sequence T1˜T8, the counter unit 40 transmits the generated selection data GC to the plurality of selecting units 20˜27 for controlling the plurality of selection units 20˜27 to output the plurality of gamma voltages G0˜G63 in the time-division method. Here, the time-division method means that, at each time sequence T1˜T8, the gamma voltage generating circuit 10 outputs the plurality of gamma voltage G0˜G63 of different values via the plurality of selecting units 20˜27 for driving the panel.

Refer again to FIG. 1, which clearly shows that the gamma voltage generating circuit 10 outputs 64 gamma voltages G0˜G63 to the plurality of selecting units 20˜27, which are coupled to 8 gamma voltages, respectively. In other words, the selecting unit 20 is coupled to the gamma voltages G0˜G7; the selecting unit 21 is coupled to the gamma voltages G8˜G15; . . . the selecting unit 27 is coupled to the gamma voltage G56˜G63. Thereby, when the selection data are 0, the selecting unit 20 selects to receive the first gamma voltage G0 coupled thereto; the selecting unit 21 selects to receive the first gamma voltage G8 coupled thereto; . . . the selecting unit 27 selects to receive the first gamma voltage G56 coupled thereto. That is to say, the eight gamma voltages GS0˜GS7 output by the plurality of selecting units 20˜27 are G0, G8, . . . G56, respectively. If the selection data are 1, the selecting unit 20 selects to receive the second gamma voltage G1 coupled thereto; the selecting unit 21 selects to receive the second gamma voltage G9 coupled thereto; . . . the selecting unit 27 selects to receive the second gamma voltage G57 coupled thereto. Namely, the eight gamma voltages GS0˜GS7 output by the plurality of selecting units 20˜27 are G1, G9, . . . G57, respectively.

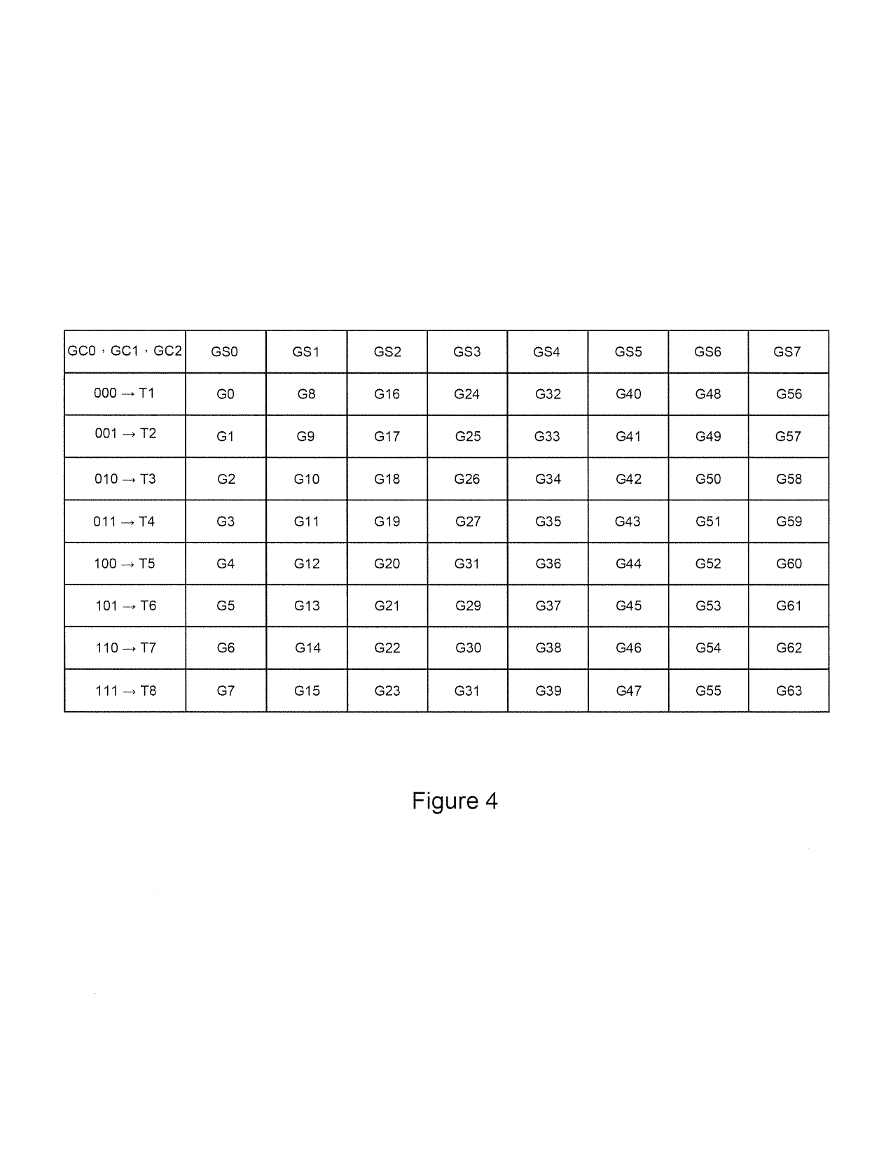

FIG. 4 shows the details of the plurality of selecting units 20˜27 selecting the plurality of gamma voltages G0˜G63 according to the other selection data GC and outputting eight gamma voltages. The figure shows the gamma voltage table of the gamma voltage generating circuit according to the present invention. As shown in the figure, if the selection data GC are 7, the selecting unit 20 selects to receive the eighth gamma voltage G7; the selecting unit 21 selects to receive the eighth gamma voltage G15; . . . the selecting unit 27 selects to receive the eighth gamma voltage G63. In other words, the eight gamma voltages GS0˜GS7 output by the plurality of selecting units 20˜27 are G7, G15, . . . G63, respectively. Thereby, the plurality of selecting units 20˜27 change the output gamma voltages G0, . . . G62, or G63 of the eight gamma voltages GS0˜GS7 at the different time sequence T1, . . . T7, or T8. Hence, the plurality of selecting units 2027 according to the present invention use the time-division concept to select the 64 gamma voltages G0˜G63 generated by the gamma voltage generating circuit 10 and produce eight gamma voltages GS0˜GS7 for the source driving circuit 30 to select and drive the pixels of the panel of the display.

As shown in FIG. 4, the table can be changed according to the requirement of the color resolution of a display. If the color resolution of the display is 3 bits, the gamma voltage table stores 8 gamma voltage levels; if the color resolution of the display is 6 bits, the gamma voltage table stores 64 gamma voltage levels. According to the embodiment of the present invention, the color resolution is 6 bits. Thereby, when the logic data GC0, GC1, GC2 are 010=2, the eight gamma voltages GS0˜GS7 output by the plurality of selecting units 20˜27 according to the logic data GC0, GC1, GC2 are G2, G10, G18, G26, G34, G42, G50, and G50, respectively. The results of the eight gamma voltages GS0˜GS7 output by the plurality of selecting units 20˜27 according to the rest logic data GC0, GC1, GC2 are shown in FIG. 4; the details will be described further. In addition, the gamma voltage table according to the present embodiment is used for explaining clearly how the plurality of selecting units 20˜27 select in the time-division method the 64 gamma voltages output by the gamma voltage generating circuit 10 according to the selection data and hence generate the eight gamma voltages GS0˜GS7 for the source driving circuit 30 to select and driving the display. Nonetheless, the present embodiment does not requires an additional storage unit in the architecture of the driving circuit of the display for storing the gamma voltage table before the plurality of selecting units 20˜27 can select in the time-division method the 64 gamma voltages according to the selection data GC.

Refer again to FIGS. 1, 2, and 4. According to the embodiment of the present invention, the plurality of selecting units 20˜27 are used for reducing the area of the interconnection between the DAC of each source driving circuit and the inside of the chip. As shown in FIG. 1, when the gamma voltage generating circuit 10 generates the 64 gamma voltages G0˜G63 complying with the 6-bit color resolution of the display, 64 wires are required for outputting the 64 gamma voltages G0˜G63. Nonetheless, when the color resolution of the display is increased to 8 bits, the gamma voltage generating circuit 10 generates 256 gamma voltages G0˜G255, which require 256 wires for outputting the 256 gamma voltages G0˜G255. Thereby, while using the plurality of selecting units 20˜27 having 8 data ports and 3 select ports, as shown in FIG. 1, the 64 wires originally required by the gamma voltage generating circuit 10 have decreased to only 8.

If the plurality of selecting units 20˜23 have 16 data ports and 4 select ports, the 64 wires originally required by the gamma voltage generating circuit 10 have decreased to only 4. In other words, the circuit area occupied by the source driving circuit 30 is reduced substantially. Besides, the logic data contained in the selection data GC also needs to be changed to 4-bit data GC0˜GC3 for controlling the plurality of selecting units 20˜23 to select 64 gamma voltages G0˜G63 and generate 4 gamma voltage GS0˜GS3. Moreover, the number of the plurality of selecting units 1027 is a multiple of the number of the plurality of gamma voltages G0˜G63. Thereby, when the color resolution of the display is enhanced, the circuit area will not increase owing to the huge number of the wires of the gamma voltage generating circuit and of the interconnection between the gamma voltage generating circuit 10 and the source driving circuit 30. Accordingly, the present invention can reduce the manufacturing cost of the display device as well as the loss in interconnection. Namely, the present invention is a driving circuit for panel that reduces substantially the area of the interconnection between the DAC of each source driving circuit and the inside of the chip. Thereby, the usable circuit area is increased.

As shown in FIG. 2, the source driving circuit 30 is coupled to the plurality of selecting units 20˜27, and selects the gamma voltage GS0 . . . GS6, or GS7 output by one of the plurality of selecting units 20 . . . 26, or 27 according to the display data S_{DSP}. In addition, the source driving circuit 30 produces a driving signal SO according to the gamma voltage GS0 . . . GS6, or GS7 of the selected selecting unit 20 . . . 26, or 27 for driving the panel of the display. The display data S_{DSP} according to the present invention is the data to be displayed on the panel. The display data S_{DSP} include first data S_{DSP1} and second data S_{DSP2}. According to the present embodiment, 6-bit display data S_{DSP} are used for description, which means that the display data S_{DSP} are binary values ranged from 000000 to 111111. Here, the value of the display data S_{DSP} is 010101 for example. The most significant three bits CD0, CD1, CD2 mean that the first data S_{DSP1} are 010, while the least significant three bits CD3, CD4, CD5 mean that the second data S_{DSP2} are 101. Besides, although 6-bit display data S_{DSP} are used for description according to the present embodiment, the display data S_{DSP} are not limited to 6 bits; they can be 4-bit or 8-bit data. Furthermore, the distribution of the data bits of the first and second data S_{DSP1}, S_{DSP2} is not limited to uniform distribution. It is possible that the first data S_{DSP1} have 2 bits while the second data S_{DSP2} have 4 bits. Thereby, if the designer wishes to change the 6-bit display data S_{DSP} to other-bit one or redistribute the bit data to the first and second data S_{DSP1}, S_{DSP2}, by modifying the source driving circuit 30 according to the present invention, the purposes of the reducing the interconnection between the DAC and the inside of the chip still can be achieved. The details will not be described any further.

The source driving circuit 30 comprises a comparing unit 301, a digital-to-analog converting (DAC) circuit 302, and a capacitor 303. The comparing unit 301 of the source driving circuit 30 is coupled to the counter unit 40 and receives the selection data GC as well as the first data S_{DSP1}, which are 010. Then, the comparing unit 301 compares the first data S_{DSP1} and the selection data GC and produces a timing signal CMPO. The selection data GC produced by the counter unit 40 are produced sequentially according to the time sequences T1˜T8. Namely, the selection data GC are produced as 000 . . . 011, or 111 sequentially at the first time sequence T1, the second time sequence T2 . . . , and the eighth time sequence T8, respectively. Thereby, the comparing unit 301 according to the present invention compares sequentially the selection data GC of 000 with the first data S_{DSP1}, the selection data GC of 100 with the first data S_{DSP1} . . . , and the selection data GC of 111 with the first data S_{DSP1} Nonetheless, because the first data S_{DSP1} is 010, when the counter unit 40 counts the selection data GC as 000 . . . 010 and less than or equal to the first data S_{DSP1} with the value of 010, the comparing unit 301 outputs a high-level, namely, logic “1”, timing signal CMPO. On the contrary, when the counter unit 40 counts the selection data GC as 110 . . . 111 and greater than the first data S_{DSP1} with the value of 010, the comparing unit 301 outputs a low-level, namely, logic “0”, timing signal CMPO.

The comparing method of the comparing unit 301 described above is only used for illustration but not for limiting the design scope of the comparing unit 301. Thereby, the comparing unit 301 can be designed as outputting a high-level timing signal CMPO when the counter unit 40 counts the selection data GC as greater than the first data S_{DSP1} and a low-level timing signal CMPO when the counter unit 40 counts the selection data GC as less than or equal to the first data S_{DSP1}. Besides, the counter unit 40 can count up or count down the selection data GC for the comparing unit 301. Likewise, the comparing unit 301 can compare the selection data GC with the first data S_{DSP1} sequentially and output low- or high-level timing signal CMPO to the DAC circuit 302.

According to the timing signal CMPO, the DAC circuit 302 according the present invention can know the time sequence T1 . . . T7, or T8 of the target voltage V_{TAR} when the target voltage V_{TAR} is equal to the gamma voltage GS0 . . . GS6, or GS7 output to the source driving circuit 30 by the selecting unit 20 . . . 26, or 27. In other words, the target voltage V_{TAR} corresponds to the time sequence T1 . . . T7, or T8, and the DAC circuit 302 knows when the target voltage V_{TAR} corresponds to the time sequence T1 . . . T7, or T8 according to the timing signal CMPO. Taking FIG. 4 for example, if the display data S_{DSP} are 010101, the first data S_{DSP1} of the display data S_{DSP} are 010. The comparing unit 301 compares sequentially the selection data GC output by the counter unit 40 with the first data S_{DSP1} from the first time sequence T1 to the eighth time sequence T8. When the selection data GC are less than or equal to the first data S_{DSP1}, the low-level timing signal CMPO is output. Consequently, when the voltage level of the timing signal CMPO changes, it is known that the target voltage V_{TAR} is located at the third time sequence T3.

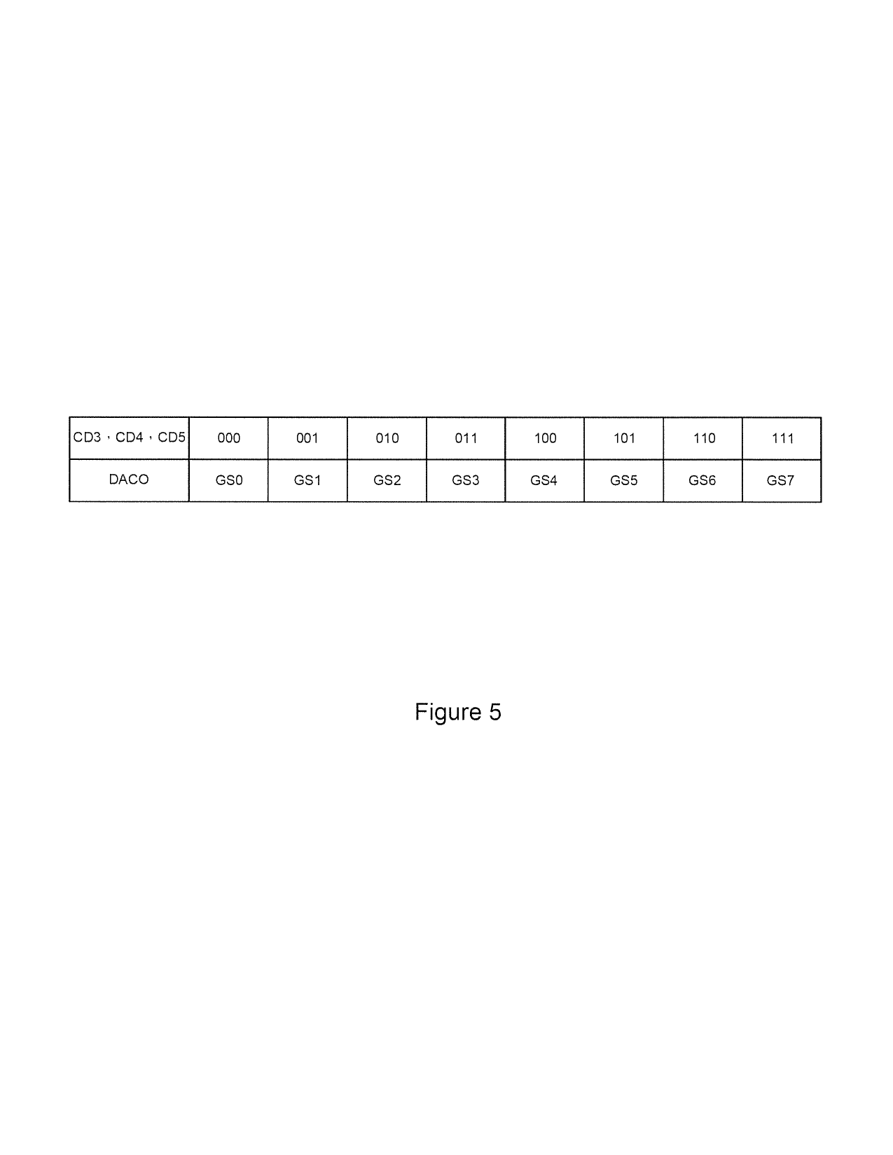

Refer to FIG. 2 and FIG. 5. FIG. 5 shows a selection table of the output voltage of the DAC circuit according to the present invention. As shown in the figures, the DAC circuit 302 is coupled to the plurality of selecting units 20˜27 and the comparing unit 301. The DAC circuit 302 receives the timing signal CMPO, the second data S_{DSP2} and one of the plurality of gamma voltages GS0˜GS7 output by the plurality of selecting units 20˜27. The DAC circuit 302 selects one of the plurality of gamma voltages GS0˜GS7 output by the plurality of selecting units 20˜27 as the output voltage DACO of the DAC circuit 302 according to the second data S_{DSP2}. When the timing signal CMPO is high, the DAC circuit 302 outputs according to the selected gamma voltage GS0 . . . GS6, or GS7. When the timing signal CMPO is low, the DAC circuit 302 still selects one of the plurality of gamma voltages GS0˜GS7 according to the second data S_{DSP2}. Nonetheless, the DAC circuit 302 will not output the plurality of gamma voltages GS0˜GS7 because the timing signal CMPO is low. In other words, when the DAC circuit 302 receives the high timing signals CMPO repeatedly, the DAC circuit 302 keeps outputting the gamma voltage GS0 . . . GS6, or GS7 output by the selecting unit 20˜27 selected by the second data S_{DSP2} at different time sequences T1 . . . T7, or T8 until the DAC circuit 302 receives the low timing signal CMPO. Thereby, the DAC circuit 302 knows the target voltage V_{TAR} is just the gamma voltage GS0 . . . GS6, or GS7 at the time sequence right before the one when the DAC circuit 302 stops outputting the gamma voltage GS0 . . . GS6, or GS7. For example, when the DAC circuit 302 stops outputting the gamma voltage GS0 . . . GS6, or GS7 at the third time sequence, the DAC circuit 302 knows that the gamma voltage generated at the second time sequence T2 is the target voltage V_{TAR}.

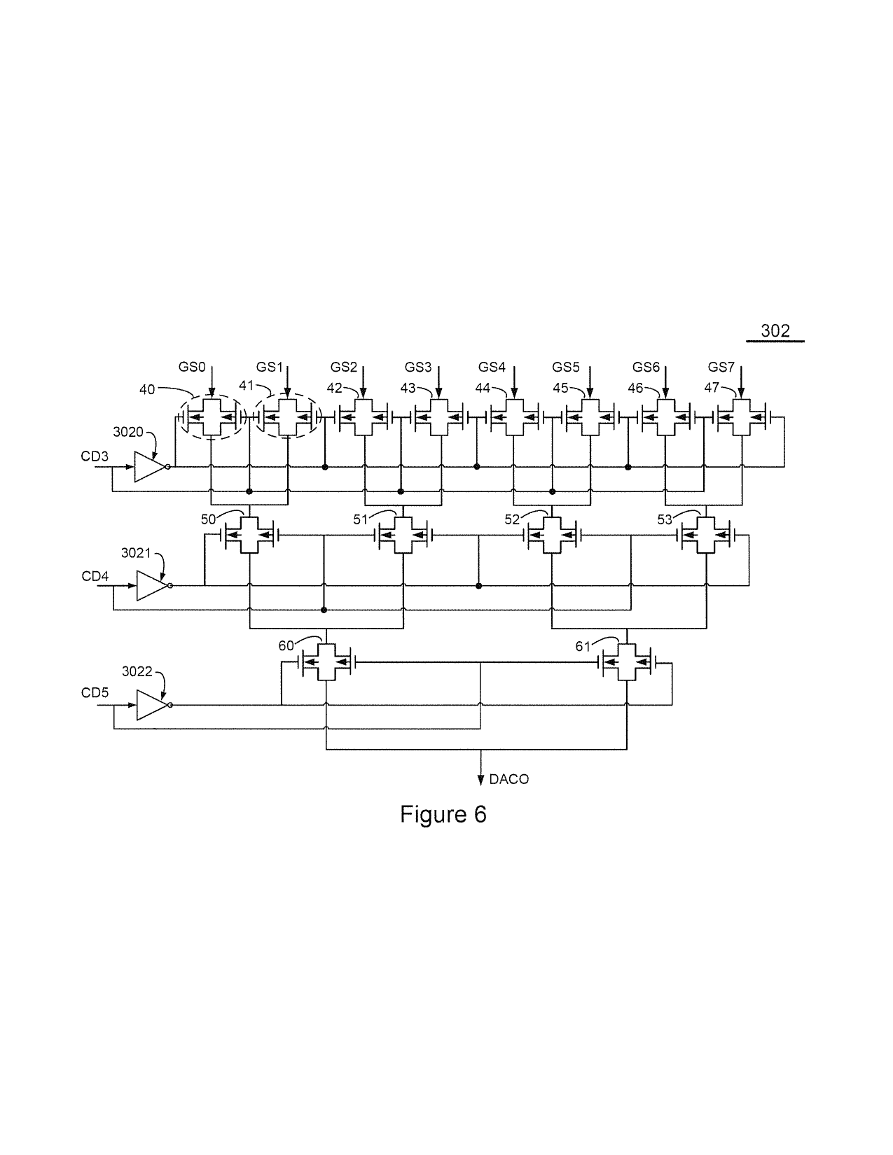

FIG. 6 shows a DAC circuit according to an embodiment of the present invention. As shown in the figure, the DAC circuit 302 according to the present invention comprises a plurality of inverters 3020˜3022 and a plurality of transmission gates 40˜47, 50˜53, 60˜61. Thereby, according to the second data S_{DSP2}, the plurality of inverters 3020˜3022 control the plurality of transmission gates 40˜47, 50˜53, 60˜61 to transmit the gamma voltages GS0˜GS7 selectively to the source driving circuit 30 for driving the panel. The plurality of transmission gates 40˜47 are connected in series and receive the gamma voltages GS0˜GS7, respectively. In addition, the plurality of transmission gates 50˜53 are connected in series; the plurality of transmission gates 60˜61 are connected in series for outputting the output voltage DACO. The inverter 3020 is coupled to the plurality of transmission gates 40˜47 for controlling turning on or off of the transmission gates 40˜47; the inverter 3021 is coupled to the plurality of transmission gates 50˜53 for controlling turning on or off of the transmission gates 50˜53; and the inverter 3022 is coupled to the plurality of transmission gates 60˜61 for controlling turning on or off of the transmission gates 60˜61. Each of the plurality of transmission gates 40˜47, 50˜53, 60˜61 are composed by an n-type metal-oxide-semiconductor transistor (NMOS) and a p-type MOS (PMOS). The drain of the NMOS is coupled to the source of the PMOS; the source of the NMOS is coupled to the drain of the PMOS. The gate of the NMOS of the transmission gate 40 is coupled to the output of the inverter 3020; the gate of the PMOS of the transmission gate 40 is coupled to the input of the inverter 3020. The source of the NMOS of the transmission gate 40 and the drain of the PMOS of the transmission gate 40 are further coupled to the transmission gate 41 and the transmission gate 50 for transmitting the gamma voltage GS0 to the transmission gate 50. The difference between the transmission gates 41, 40 is that the gate of the NMOS of the transmission gate 41 is coupled to the input of the inverter 3020, and the gate of the PMOS of the transmission gate 41 is coupled to the output of the inverter 3020.

In addition, the source of the NMOS of the transmission gate 41 and the drain of the PMOS of the transmission gate 41 are further coupled to the transmission gate 50 for transmitting the gamma voltage GS1 to the transmission gate 50. Likewise, the source of the NMOS of the transmission gate 42, the drain of the PMOS of the transmission gate 42, the source of the NMOS of the transmission gate 43, and the drain of the PMOS of the transmission gate 43 are coupled to the transmission gate 51; the coupling among the transmission gate 42, the transmission gate 43, and the inverter 3020 is similar to the coupling among the transmission gate 40, the transmission gate 41, and the inverter 3020. Besides, the coupling among the transmission gates 44˜47, 50˜53, 60˜61 and the inverters 3021˜3022 is similar to the coupling among the transmission gates 40˜43 and the inverter 3020. Hence, please refer to FIG. 6 for the detailed coupling among the transmission gates 44˜47, 50˜53, 60˜61 and the inverters 3021˜3022; the description will not be repeated again.

Accordingly, when the plurality of inverters 3020˜3022 of the DAC circuit 302 receive the second data S_{DSP2} of 1 (CD3), 0 (CD4), and 1 (CD5), respectively, the bit datum CD3 with the value 1 controls and turns on the transmission gates 41, 43, 45, 47 via the inverter 3020 for transmitting the gamma voltage GS1 to the transmission gate 50, the gamma voltage GS3 to the transmission gate 51, the gamma voltage GS5 to the transmission gate 52, and the gamma voltage GS7 to the transmission gate 53, respectively. In addition, the bit datum CD4 with the value 0 controls and turns on the transmission gates 50, 52 via the inverter 3021 for transmitting the gamma voltage GS1 to the transmission gate 60 and the gamma voltage GS5 to the transmission gate 61, respectively; and the bit datum CD5 with the value 1 controls and turns on the transmission gate 61 via the inverter 3022 for outputting the gamma voltage GS5, which is just the output voltage DACO of the DAC circuit 302. Nonetheless, FIG. 6 is only an embodiment of how the DAC circuit 302 according to the present invention selects the plurality of gamma voltages GS0˜GS7; the present invention does not limit the way the DAC circuit 302 is composed. For example, a plurality of comparators can be used for receiving the bit data CD3˜CD5, respectively, for controlling a plurality of transistors to output one of the plurality of gamma voltages GS0˜GS7 selectively as the driving signal SO for driving the panel.

As shown in FIG. 2, the capacitor 303 is coupled to the output of the DAC circuit 302. The capacitor 303 produces a driving signal SO according the target voltage V_{TAR} for driving the panel. That is to say, when the DAC circuit 302 receives the high-level timing signal CMPO, the DAC circuit 302 will select one of the gamma voltages GS0˜GS7 according to the second data S_{DSP2} and output the selected gamma voltage to the capacitor 303 for charging or discharging until the DAC circuit 302 receives the low-level timing signal CMPO, in which time the output signal of the DAC circuit 302 is floating. Meanwhile, control the stored voltage S_{DR1} across the capacitor 303 to be the driving voltage SO for driving the panel. When the DAC circuit 302 does not output the gamma voltage, the source of an amplifying unit 304, which outputs the driving signal SO, is, instead of the gamma voltage output by the DAC circuit 302, changed to be supplied by the driving signal S_{DR1} on the capacitor 303. Thereby, the driving signal S_{DR1} is amplified to the driving signal SO by the amplifying unit 304 and is output for driving the panel. In addition, the source driving circuit 30 can further include a buffer unit 305 for storing the display data S_{DSP} and accelerating the comparing unit 301 and the DAC circuit 302 to read the first and second data S_{DSP1}, S_{DSP2}, respectively, for producing the driving signal and driving the panel.

According to the above description, when the display data S_{DSP} received by the buffer unit 305 is 010101, the counter unit 40 starts to count the first selection data as 000, as shown in FIG. 5, according to the second data S_{DSP2} of 1 (CD3) 0 (CD4) 1 (CD5)=5, the DAC circuit 302 selects the gamma voltage GS5 output by the sixth selecting unit 25 among the plurality of gamma voltages GS0˜GS7 output by the plurality of selecting units 20˜27. At the next time sequence T1 . . . T7, or T8, as the DAC circuit 302 keeps receiving the high-level timing signal CMPO, the DAC circuit 302 still outputs the gamma voltage GS5 output by the sixth selecting unit 25, and so on. When the counter unit 40 counts to the third selection data GC as 010, because the DAC circuit 302 receives the high-level timing signal CMPO repeatedly, the selected sixth gamma voltage GS5 is output to the capacitor 303 for charging it until the counter unit 40 counts to the fourth selection data GC as 110. After the DAC circuit 302 receives the low-level timing signal CMPO, the DAC circuit 302 stops outputting the gamma voltage GS5 output by the selected sixth selecting unit 25. As shown in FIG. 4, when the first selection data GC is 000, the gamma voltage GS5 output by sixth selecting unit 25 of the DAC circuit 302 according to the second data S_{DSP2} is G40; when the second selection data GC is 100, the gamma voltage GS5 output by sixth selecting unit 25 of the DAC circuit 302 according to the second data S_{DSP2} is G41; when the third selection data GC is 010, the gamma voltage GS5 output by sixth selecting unit 25 of the DAC circuit 302 according to the second data S_{DSP2} is G42. Thereby, the last voltage output by the DAC circuit 302 is the gamma voltage of G42.

The gamma voltage output by the DAC circuit 302 will charge the coupled capacitor 303 and produce the driving signal S_{DR1}. Besides, the amplifying unit 304 is coupled to the capacitor 303 and the DAC circuit 302. Thereby, the amplifying unit 304 will produce the amplified driving signal SO according to the driving signal S_{DR1} for driving the display or panel and hence producing the required picture. Moreover, because the gamma voltage output by the DAC circuit 302 changes from the gamma voltage of G40 to the gamma voltage of G41 and to the gamma voltage of G42, the driving signal S_{DR1} produced by the capacitor 303 changes gradually from the gamma voltage of G40 to the gamma voltage of G42. The final gamma voltage G42 charging the capacitor 303 is the target voltage V_{TAR}. On the contrary, if the counter unit 40 is the count-down counting, namely, the selection data GC count from 7 back to 0, the voltage of the driving signal S_{DR1} produced by the capacitor 303 is the gamma voltage of G42, which is the target voltage V_{TAR}. This is well known to a person having ordinary skill in the art; the details will not be described further. Nevertheless, the embodiment adopts count-up counting. Thereby, after the driving signal S_{DR1} of the capacitor 303 is changed from the gamma voltage of G40 to the gamma voltage of G42, it is amplified by an amplifying unit 304 to the driving signal SO and is output for driving the panel.

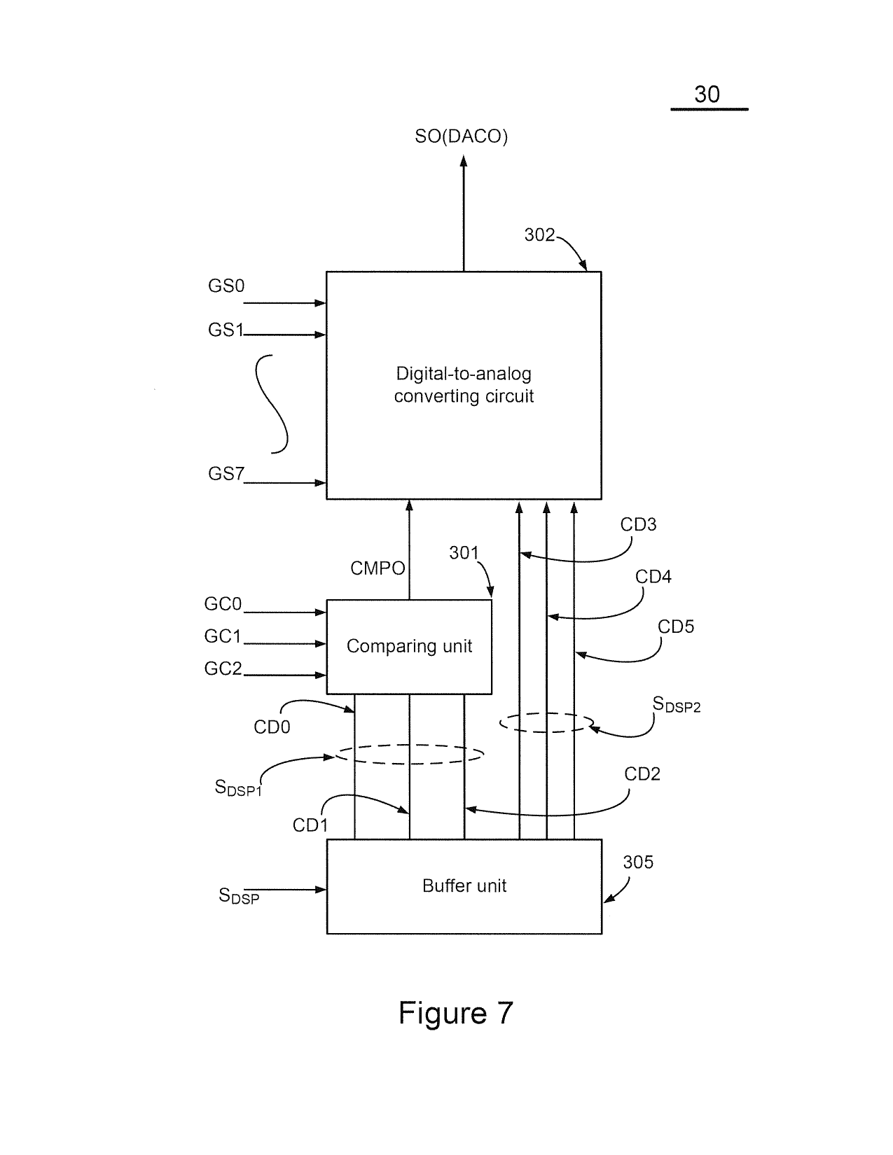

FIG. 7 shows another block diagram of the source driving circuit 30 according to the present invention. As shown in the figure, according to the characteristics of different panels, the capacitor 303 and the amplifying unit 304 can be further omitted in the design of the source driving circuit 30 according to the present invention. Thereby, the source driving circuit 30 needs not to control the charging and discharging of the capacitor 303 and produce the driving signal S_{DR1}. Moreover, the source driving circuit 30 needs not to amplify the driving signal S_{DR1} using the amplifying unit 304 and produce the driving signal SO before driving the panel. Instead, the source driving circuit 30 outputs the output voltage DACO produced by the DAC circuit 30 directly for driving the panel. Consequently, while driving different panels, the source driving circuit 30 according to the present invention can reduce substantially the interconnection inside the chip as well as the number of the DAC circuits 302. Depending on the types of panels, the internal circuit of the source driving circuit 30 can be designed compact, and thereby shrinking the chip area and saving the manufacturing cost.

To sum up, the present invention provides a driving circuit for panel, which comprises a gamma voltage generating circuit, a plurality of selecting units, and at least a source driving circuit. The gamma voltage generating circuit generates a plurality of gamma voltages for the plurality of selecting units. The plurality of selecting units outputs the plurality of gamma voltages generated by the gamma voltage generating circuit using the time-division method according to selection data to the source driving circuit. According to display data, the source driving circuit selects to receive the gamma voltage of an output of the plurality of selecting units as a target voltage. In addition, the source driving circuit produces a driving signal according to the target voltage for driving a panel.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A driving circuit for panel, comprising:
a gamma voltage generating circuit, generating a plurality of gamma voltages;
a plurality of selecting units, coupled to said gamma voltage generating circuit, and outputting said plurality of gamma voltage in the time-division method according selection data; and
at least a source driving circuit, coupled to said plurality of selecting units, selecting to receive the gamma voltage output by one of said selecting units as a target voltage according to display data, and producing a driving signal according to said target voltage for driving a panel.

2. The driving circuit for panel of claim 1, and further comprising a counter unit, coupled to said plurality of selecting units, producing said selection data according to a time sequence, and transmitting said selection data to said plurality of selecting units for controlling said plurality of selecting units to outputting said plurality of gamma voltage in the time-division method.

3. The driving circuit for panel of claim 1, wherein said source driving circuit comprises:
a comparing unit, receiving first data of said display data, and comparing said first data with said selection data for producing a timing signal;
a digital-to-analog converting circuit, coupled to said plurality of selecting units and said comparing unit, said digital-to-analog converting circuit selecting the gamma voltage output by one of said plurality of selecting units as said target voltage according to second data of said display data and said timing signal; and
a capacitor, coupled to said digital-to-analog converting circuit, and producing a driving signal according to said target voltage for driving said panel.

4. The driving circuit for panel of claim 3, and further comprising a buffer unit, receiving said display data, outputting said first data of said display data to said comparing unit, and outputting said second data of said display data to said digital-to-analog converting circuit.

5. The driving circuit for panel of claim 3, wherein said source driving circuit further comprises an amplifying unit, coupled to said digital-to-analog converting circuit and said capacitor for amplifying said driving signal and driving said panel.

6. The driving circuit for panel of claim 3, wherein said comparing unit compares and when said selection data are less than or equal to said first data, said digital-to-analog converting circuit outputs said target voltage and charges said capacitor; when selection data are greater than said first data, said digital-to-analog converting circuit controls said capacitor to output said driving signal for driving said panel.

7. The driving circuit for panel of claim 3, wherein said comparing unit compares and when said selection data are greater than said first data, said digital-to-analog converting circuit outputs said target voltage and charges said capacitor; when selection data are less than or equal to said first data, said digital-to-analog converting circuit controls said capacitor to output said driving signal for driving said panel.

8. The driving circuit for panel of claim 1, wherein the number of said plurality of selecting units is a multiple of the number of said plurality of gamma voltages.

9. The driving circuit for panel of claim 1, wherein said gamma voltage generating circuit generates said plurality of gamma voltages according to a gamma curve.
